(19) United States
(12) Patent Application Publication
(10) Pub. No.: US 2007/0139327 A1
(43) Pub. Date: Jun. 21, 2007

(54) DOT INVERSION DRIVING APPARATUS FOR ANALOG THIN FILM TRANSISTOR LIQUID CRYSTAL DISPLAY PANEL AND METHOD THEREOF

(76) Inventors: Hsiang-Lun Liu, Taoyuan County (TW); I-Cheng Liu, Changhua County (TW); Kuan-Hung Liu, Taipei Hsien (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 11/306,166

(22) Filed: Dec. 19, 2005

(51) Int. Cl. G09G 3/36

(52) U.S. Cl. 345/89

(57) ABSTRACT

A dot inversion driving apparatus for an analog thin film transistor liquid crystal display (TFT LCD) panel and the method thereof are disclosed. The driving apparatus includes a control circuit and a source driver IC. The control circuit rearranges the orders and polarities of the grayscale signals of the TFT LCD panel, divides the grayscale signals into two groups, and outputs one of the groups during one of two half periods of each frame. The source driver IC collects the grayscale signals output by the control circuit. During the first half period using one scan line of the first group as a unit, the source driver IC outputs the grayscale signals to the pixels of the first group; and during the second half period using one scan line of the second group as a unit, the source driver IC outputs the grayscale signals to the pixels of the second group.

### BACKGROUND OF THE INVENTION

1. Field of Invention

The present invention relates to a driving apparatus and method for a thin film transistor liquid crystal display panel (TFT LCD panel). More particularly, the present invention relates to a dot inversion driving apparatus and method for an analog thin film transistor liquid crystal display panel.

2. Description of Related Art

FIG. 1 is a schematic diagram of a driving circuit of a conventional medium to small sized analog TFT LCD panel. The driving circuit shown in FIG. 1 includes an image processing circuit 101, a timing controller 102 and a source driver IC 103. The image processing circuit 101 extracts the analog grayscale signals Va, Vb and Vc of RGB trichromatism from the image signal 110, and then provides Va, Vb and Vc to the source driver IC 103. The image processing circuit 101 and the timing controller 102 exchange the synchronization signal 112. The timing controller 102 provides the control signals 111, such as the clock signal, to the gate driver IC (not shown in FIG. 1) and the source driver IC 103 of the TFT LCD panel. The function of the source driver IC 103 is to output the grayscale signals Va, Vb and Vc to the pixels of the TFT LCD panel.

To reduce cost, the line inversion driving mode is mostly used in the conventional medium to small sized analog TFT LCD panel. Taking FIG. 2 as an example, G1 to G4 represent four neighboring scan lines in the panel while R, G and B represent the three sub-pixels (or “dot”) comprising a pixel corresponding to red, green and blue. P represents the positive polarity and N represents the negative polarity. As shown in FIG. 2, the so-called “line inversion” means that in the same frame two neighboring scan lines use contrary driving polarities, and that the polarity of the same scan line reverses between two consecutive frames.

The common voltage of the traditional TFT LCD panel can be direct current or alternating current. The common voltage of direct current is constant while the common voltage of alternating current reverses along with the driving polarities, as shown in FIG. 3. FIG. 3 is a schematic oscillogram of the alternating current common voltage, VCOM, and the grayscale signal, GS. Wherein, when the grayscale signal GS is in positive polarity (P), the common voltage VCOM drops into VcomL which is lower than the voltage of the grayscale signal GS. On the other hand, when the grayscale signal GS is in negative polarity (N), the common voltage VCOM rises to VcomH which is higher than the voltage of the grayscale signal GS.

As to the display quality, the line inversion driving mode of the traditional medium to small sized analog TFT LCD panel easily produces crosstalk and flickers. If the dot inversion driving mode is applied to improve the display quality, the cost will greatly increase due to the complicated circuit.

### SUMMARY OF THE INVENTION

Accordingly, the present invention is directed to provide a dot inversion driving apparatus for an analog thin film transistor liquid crystal display panel so that the grayscale data of line inversion can be output by way of dot inversion and that the display quality of dot inversion can be obtained at a lower cost.

Besides, the present invention provides a dot inversion driving method for an analog thin film transistor liquid crystal display panel. Like the above driving apparatus, the grayscale data of line inversion can be output by way of dot inversion and that the display quality of dot inversion can be obtained at a lower cost.

In order to achieve the above and other objects, the present invention provides a dot inversion driving apparatus for an analog thin film transistor liquid crystal display panel. The driving apparatus includes a control circuit and a source driver IC. The control circuit receives the grayscale signal of the thin film transistor liquid crystal display panel from the front step system, rearranges the orders and polarities of the grayscale signals, and then outputs the grayscale signals of the first group during the first half period of each frame and outputs the grayscale signals of the second group during the second half period of each frame. The source driver IC collects the grayscale signals output by the control circuit. During the first half period, using one scan line of the first group as a unit, the source driver IC outputs the grayscale signals to the pixels of the first group, and during the second half period, using one scan line of the second group as a unit, the source driver IC outputs the grayscale signals to the pixels of the second group.

Wherein, the grayscale signals received by the control circuit change their polarities according to the line inversion driving mode. The aforementioned first group is the whole odd data lines or the whole even data lines of the aforementioned panel. The aforementioned second group is the whole data lines of the aforementioned panel deducting the first group. In the grayscale signals of the first group, all the odd scan lines are of the first polarity while all the even scan lines are of the second polarity. In addition, in the grayscale signals of the second group, all the odd scan lines are of the second polarity while all the even scan lines are of the first polarity.

In an embodiment of the aforementioned dot inversion driving apparatus for an analog thin film transistor liquid crystal display panel, the control circuit further outputs a first clock signal and a second clock signal. The source driver IC collects grayscale signals during the first half period based on the first clock signal while it collects grayscale signals during the second half period based on the second clock signal.

In an embodiment of the aforementioned dot inversion driving apparatus for an analog thin film transistor liquid crystal display panel, the common voltage of the aforementioned panel is alternating circuit voltage. When the grayscale signal output by the source driver IC is of the first polarity, the aforementioned common voltage is the first voltage; when the grayscale signal output by the source driver IC is of the second polarity, the aforementioned common voltage is the second voltage.

In an embodiment of the aforementioned dot inversion driving apparatus for an analog thin film transistor liquid crystal display panel, the first polarity is either positive polarity or negative polarity. If the first polarity is the positive polarity, the second polarity is the negative polarity and the aforementioned first voltage is lower than the voltage of the grayscale signal and the aforementioned second voltage is higher than the voltage of the grayscale signal. On the other hand, if the first polarity is the negative polarity, the second polarity is the positive polarity and the aforementioned first voltage is higher than the voltage of the grayscale signal and the aforementioned second voltage is lower than the voltage of the grayscale signal.

Based on the aforementioned dot inversion driving apparatus, the present invention further provides a dot inversion driving method for an analog thin film transistor liquid crystal display panel. The method includes the following steps: first, receiving the grayscale signals of the thin film transistor liquid crystal display panel from the front step system; after rearranging the orders and polarities of the grayscale signals, outputting the grayscale signals of the first group to the pixels of the first group during the first half period of each frame using one scan line of the first group as a unit, and outputting the grayscale signals of the second group to the pixels of the second group during the second half period of each frame using one scan line of the second group as a unit.

As described in the embodiment of the present invention, the present invention modifies the traditional timing controller and source driver IC, receives the grayscale data by way of line inversion, rearranges the orders and polarities of the grayscale data, and then outputs the grayscale data in two groups by way of line inversion, so that the grayscale data of the same frame can be disposed by way of dot inversion. In the present invention, the grayscale data are output by way of line inversion, thus the circuit is not complicated as a real dot inversion driving circuit, so that the dot inversion display quality can be obtained at a lower cost.

In order to make the aforementioned and other objects, features and advantages of the present invention comprehensible, a preferred embodiment accompanied with figures is described in detail below.

### BRIEF DESCRIPTION OF THE DRAWINGS

FIG. 1 is a schematic diagram of a driving circuit of a conventional analog thin film transistor liquid crystal display panel.

FIG. 2 is a schematic diagram of pixel polarity of the line inversion driving mode.

FIG. 3 is a schematic oscillogram of alternating current common voltage and grayscale signal voltage.

FIG. 4 is a schematic drawing of a dot inversion driving apparatus for an analog thin film transistor liquid crystal display panel according to an embodiment of the present invention.

FIG. 5A and FIG. 5B illustrate how the control circuit shown in FIG. 4 rearranges the orders and polarities of grayscale signals.

FIG. 6 and FIG. 7 illustrate how the dot inversion driving apparatus outputs grayscale signals.

FIG. 8 and FIG. 9 are timing charts of the source driver IC obtaining grayscale signals according to an embodiment of the present invention.

FIG. 10 is a flow chart of a dot inversion driving method for an analog thin film transistor liquid crystal display panel according to an embodiment of the present invention.

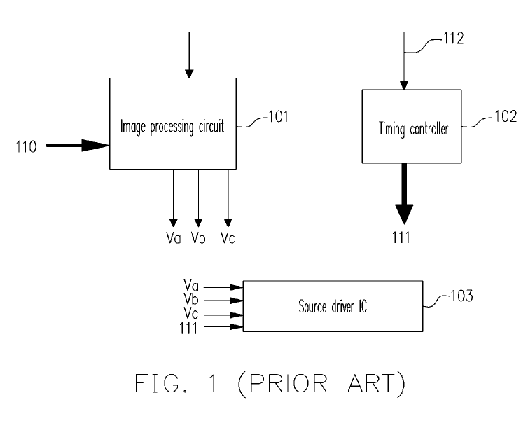

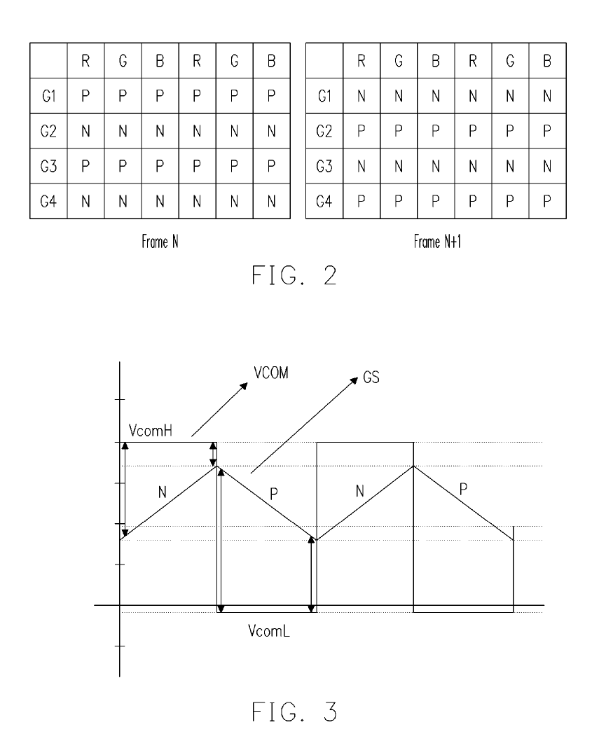

### DESCRIPTION OF EMBODIMENTS

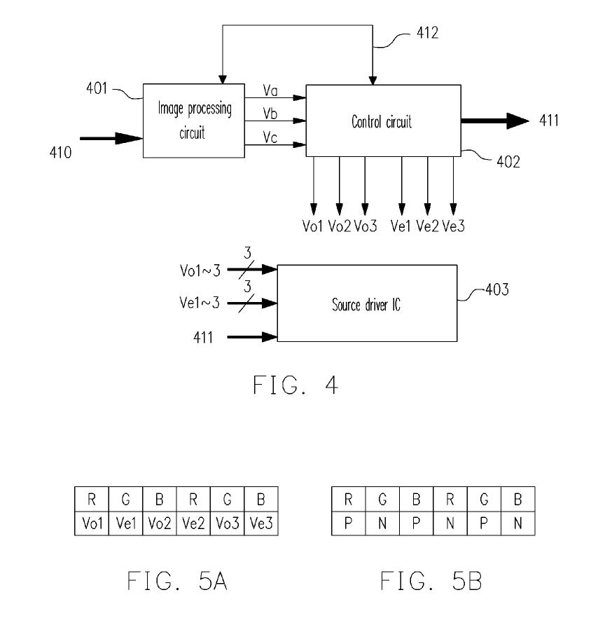

FIG. 4 is a schematic drawing of a dot inversion driving apparatus for an analog TFT LCD panel according to an embodiment of the present invention. The circuit shown in FIG. 4 includes an image processing circuit 401, a control circuit 402 and a source driver IC 403. The dot inversion driving apparatus of the present embodiment comprises the control circuit 402 and the source driver IC 403. For a simple description, it is assumed that the present embodiment uses the direct current common voltage.

First, the image processing circuit 410 extracts the analog grayscale signals Va, Vb and Vc of the RGB trichromatism from the image signal 410. Here the grayscale signals Va, Vb and Vc change their polarities according to the line inversion driving mode. The control circuit 402 receives the grayscale signals Va, Vb and Vc and exchanges the synchronization signal 412 with the image processing circuit 401. Then, the control circuit 402 rearranges the orders and polarities of the grayscale signals Va, Vb and Vc into the grayscale signals Vo1˜Vo3 and Ve1˜Ve3.

The order of the grayscale signals Vo1˜Vo3 and Ve1˜Ve3 are shown in FIG. 5A and the polarities in FIG. 5B. Namely, the control circuit 402 divides the grayscale signals into two groups. The first group includes the whole odd data lines of the panel according with the grayscale signals Vo1˜Vo3; the second group includes the whole even data lines of the panel according with the grayscale signals Ve1˜Ve3. In order to fit the dot inversion driving mode, the first group and the second group have contrary driving polarities. P represents the positive polarity; N represents the negative polarity.

In addition to the control signal 411 (details are stated below) from the control circuit 402, the source driver IC 403 also receives the grayscale signals Vo1˜Vo3 and Ve1˜Ve3. In the present embodiment, a frame is displayed in two periods. During the first half period of each frame, the control circuit 402 outputs the grayscale signals Vo1˜Vo3 of the first group to the source driver IC 403. The source driver IC 403 collects the grayscale signals Vo1˜Vo3 in series and then outputs the grayscale signals Vo1˜Vo3 to the pixels of the first group. On the other hand, during the second half period of each frame, the control circuit 402 outputs the grayscale signals Ve1˜Ve3 of the second group to the source driver IC 403. The source driver IC 403 collects the grayscale signals Ve1˜Ve3 in series and then outputs the grayscale signals Ve1˜Ve3 to the pixels of the second group.

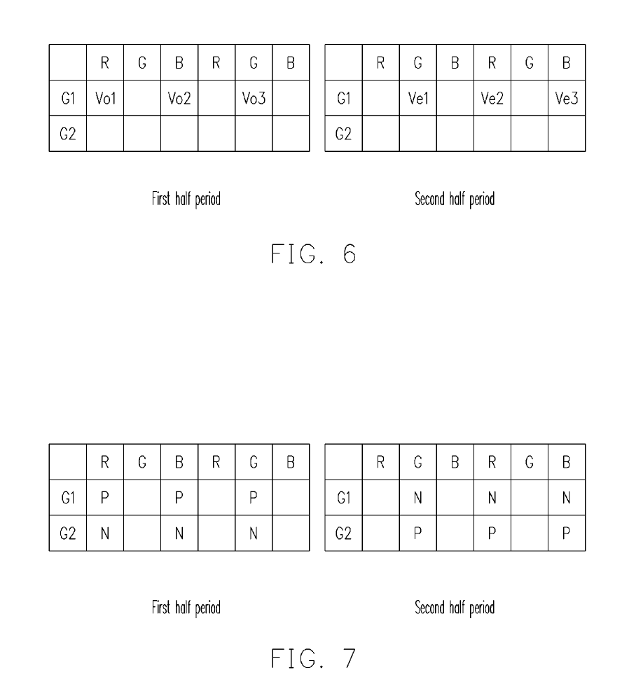

In the aforementioned process, the position of the grayscale signals on the panel is as shown in FIG. 6, and the polarities as shown in FIG. 7. Wherein, G1 and G2 represent two neighboring scan lines in the panel while R, G and B respectively represents the three sub-pixels corresponding to red, green and blue color. P represents the positive polarity and N represents the negative polarity. The characteristic of the present embodiment is that the source driver IC 403 only outputs the grayscale signals Vo1˜Vo3 of the odd data lines in the first half period of the frame and only outputs the grayscale signals Voe1˜Ve3 of the even data lines in the second half period of the frame. Besides, in the grayscale signals of the odd data lines, all the odd scan lines are of the positive polarity, and all the even scan lines are of the negative polarity. So, although the source driver IC 403 outputs the grayscale signals by way of line inversion all the time, the combination of the grayscale signals of the whole frame is in the dot inversion mode.

The TFT LCD panel of the present embodiment has a resolution of 480×234 and uses three source driver IC chips. The source driver IC 403 shown in FIG. 4 is one of them. Each pixel consists of three sub-pixels. Therefore, each source driver IC is responsible for outputting grayscale signals of 480 data lines, 240 data lines respectively in the first and the second half period of the frame.

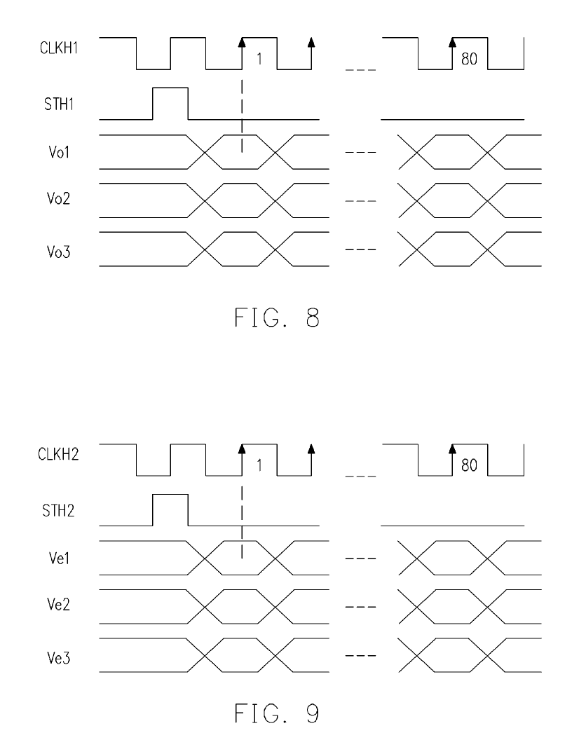

FIG. 8 is a timing chart for the source driver IC of the present embodiment collecting the first group grayscale signals Vo1˜Vo3 in the first half period of the frame. Wherein, the clock signal CLKH1 is the benchmark where the source driver IC collects the grayscale signals Vo1˜Vo3, and the start pulse STH1 notifies the source driver IC to start collecting the grayscale signals Vo1˜Vo3. The source driver IC of the present embodiment starts to collect the grayscale signals Vo1˜Vo3 at the rising edge of the clock signal CLKH1 after the positive pulse of the start pulse STH1. The source driver IC collects and outputs grayscale signals using a half scan line in the group as a unit. For example, in the first half period, the source driver IC first collects the grayscale signals of the odd sub-pixels of a whole scan line and then outputs the grayscale signals to all the odd data lines at the same time.

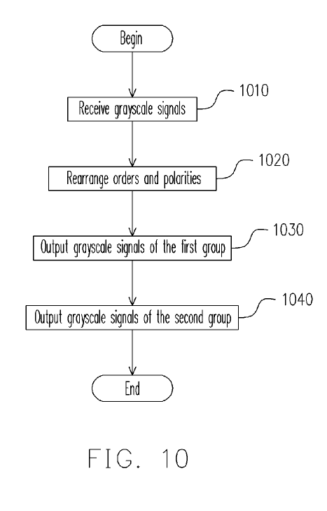

On the other hand, FIG. 9 is a timing chart for the source driver IC of the present embodiment collecting the second group grayscale signals Ve1˜Ve3 in the second half period of the frame. Wherein, the clock signal CLKH2 is the benchmark where the source driver IC collects the grayscale signals Ve1˜Ve3, and the start pulse STH2 notifies the source driver IC to start collecting the grayscale signals Ve1˜Ve3. In the same way, the source driver IC of the present embodiment starts to collect the grayscale signals Ve1˜Ve3 at the rising edge of the clock signal CLKH2 after the positive pulse of the start pulse STH2. In the second half period, the source driver IC first collects the grayscale signals of the even sub-pixels of a whole scan line and then outputs the grayscale signals to all the even data lines at the same time.

The clock signals CLKH1, CLKH2 and the start pulses STH1, STH2 all come from the control circuit 402 shown in FIG. 4 and are all contained in the control signal 411. Although the source driver IC of the present embodiment starts to collect the grayscale signals at the rising edge of the clock signal, in other embodiments of the present invention, it can also start to collect the grayscale signals at the falling edge of the clock signal.

In the above embodiment, it is assumed that the present embodiment uses the direct current common voltage. In fact, the present embodiment can also use the alternating current common voltage. If the alternating current common voltage is used, as shown in FIG. 3, the common voltage will change along with the polarities of the grayscale signals output by the source driver. Regardless of the first group or the second group, when the grayscale signal GS of a scan line is in positive polarity (P), the common voltage VCOM will drop into VcomL which is lower than the voltage of the grayscale GS. On the other hand, when the grayscale signal GS of the same line is in negative polarity (N), the common voltage VCOM will rise to VcomH which is higher than the voltage of the grayscale GS.

The number of the scan lines of the TFT LCD panel of the present embodiment is even, so that, as shown in FIG. 7, the polarity of the last scan line of the first half period of each frame is the same as the polarity of the first scan line of the second half period. Therefore, the common voltage must be unchanged during this period of time. In the same way, the polarity of the last scan line of the second half period of a frame is the same as the polarity of the first scan line of the first half period of the next frame. So, the common voltage must also be unchanged during this period of time. In the present embodiment, the control circuit 402 in FIG. 4 provides a common voltage control signal which will then be amplified by an independent amplifying circuit (not shown in FIG. 4) to produce the common voltage.

In addition to the dot inversion driving apparatus for an analog TFT LCD panel, the present invention also provides a dot inversion driving method for an analog TFT LCD panel. FIG. 10 is a flow chart of a dot inversion driving method for an analog TFT LCD panel according to an embodiment of the present invention. The flow of the method of this embodiment is the same as the operation flow of the driving apparatus of the last embodiment.

First of all, in the step 1010, the grayscale signals of the TFT LCD panel from the front step system are received. In the step 1020, the orders and polarities of the grayscale signals are rearranged, as the control circuit 402 in FIG. 4. Next, in the step 1030, during the first half period of each frame, the grayscale signals of the first group are output to the pixels of the first group using one scan line of the first group as a unit. And then, in the step 1040, during the second half period of each frame, the grayscale signals of the second group are output to the pixels of the second group using one scan line of the second group as a unit. The steps of 1030 and 1040 are when the grayscale data are transferred from the control circuit 402 and the source driver IC 403 in FIG. 4 to the pixels of the TFT LCD panel. The details of how the scan lines of two groups change their driving polarities and how the common voltage cooperates are described in the above driving apparatus, and are not repeated here.

The present invention is not limited to the above embodiments. For example, in the above embodiment, the first group includes all odd scan lines while the second group includes all even scan lines. Alternatively, in other embodiments, the first group includes all even scan lines while the second group includes all odd scan lines. In the two groups, the polarity arrangement of the scan lines may also be changed as long as the dot inversion driving mode can be achieved. For example, the first scan line of the first group may be changed into the negative polarity while the first scan line of the second group is changed into the positive polarity. Besides, in the above embodiments, the control circuit outputs the grayscale signals of three sub-pixels (e.g. Vo1˜Vo3 or Ve1˜Ve3) at one time; the source driver IC also collects the grayscale signals of three sub-pixels at one time. In fact, as long as the grayscale signals of at least one sub-pixel are output at one time, the present invention can be implemented.

In summary, the present invention modifies the traditional timing controller and source driver IC, receives the grayscale data by way of line inversion, rearranges the orders and polarities of the grayscale data, and then outputs the grayscale data in two groups by way of line inversion, so that the grayscale data of the same frame can be arranged by way of dot inversion. In the present invention, the grayscale data are output by way of line inversion, thus the circuit are not so complicated as a real dot inversion driving circuit, so that the dot inversion display quality can be obtained at a lower cost.

The present invention is disclosed above with its preferred embodiments. It is to be understood that the preferred embodiment of present invention is not to be taken in a limiting sense. It will be apparent to those skilled in the art that various modifications and variations can be made to the structure of the present invention without departing from the scope or spirit of the invention. The protection scope of the present invention is in accordance with the scope of the following claims and their equivalents.

What is claimed is:

1. A dot inversion driving apparatus for an analog thin film transistor liquid crystal display panel, comprising:
a control circuit, receiving grayscale signals of a thin film transistor liquid crystal display panel from the front step system, rearranging the orders and polarities of the grayscale signals, and then outputting the grayscale signals of a first group during a first half period of a frame and outputting the grayscale signals of a second group during a second half period of the frame; and
a source driver IC, collecting the grayscale signals output by the control circuit, then outputting the grayscale signals to the pixels of the first group during the first half period using one scan line of the first group as a unit, and outputting the grayscale signals to the pixels of the second group during the second half period using one scan line of the second group as a unit; wherein
the grayscale signals received by the control circuit change their polarities according to the line inversion driving mode;
the first group is the whole odd data lines or the whole even data lines of the thin film transistor liquid crystal display panel;
the second group is the whole data lines of the thin film transistor liquid crystal display panel deducting the first group;
in the grayscale signals of the first group, all the odd scan lines are of a first polarity while all the even scan lines are of a second polarity;
in the grayscale signals of the second group, all the odd scan lines are of the second polarity while all the even scan lines are of the first polarity.

2. The dot inversion driving apparatus for an analog thin film transistor liquid crystal display panel as claimed in claim 1, wherein, the first polarity is one of the positive polarity and the negative polarity, and if the first polarity is of positive polarity, the second polarity is of negative polarity; if the first polarity is of negative polarity, the second polarity is of positive polarity.

3. The dot inversion driving apparatus for an analog thin film transistor liquid crystal display panel as claimed in claim 1, wherein the control circuit further outputs a first clock signal and a second clock signal, the source driver IC collects the grayscale signals during the first half period according to the first clock signal and collects the grayscale signals during the second half period according to the second clock signal.

4. The dot inversion driving apparatus for an analog thin film transistor liquid crystal display panel as claimed in claim 1, wherein, the control circuit further outputs a first start pulse to notify the source driver IC to start collecting the grayscale signals during the first half period and a second start pulse to notify the source driver IC to start collecting the grayscale signals during the second half period.

5. The dot inversion driving apparatus for an analog thin film transistor liquid crystal display panel as claimed in claim 1, wherein, the common voltage of the thin film transistor liquid crystal display panel is of direct current voltage.

6. The dot inversion driving apparatus for an analog thin film transistor liquid crystal display panel as claimed in claim 1, wherein, the common voltage of the thin film transistor liquid crystal display panel is of alternating current voltage and when the grayscale signal output by the source driver IC is of the first polarity, the common voltage is a first voltage; when the grayscale signal output by the source driver IC is of the second polarity, the common voltage is a second voltage.

7. The dot inversion driving apparatus for an analog thin film transistor liquid crystal display panel as claimed in claim 6, wherein, the first polarity is one of the positive polarity and the negative polarity, and
if the first polarity is of positive polarity, the second polarity is of negative polarity and the first voltage is lower than the voltage of the grayscale signal and the second voltage is higher than the voltage of the grayscale signal;
if the first polarity is of negative polarity, the second polarity is of positive polarity and the first voltage is higher than the voltage of the grayscale signal and the second voltage is lower than the voltage of the grayscale signal.

8. The dot inversion driving apparatus for an analog thin film transistor liquid crystal display panel as claimed in claim 6, wherein, from the last scan line of the first half period to the first scan line of the second half period, the common voltage is unchanged; moreover, from the last scan line of the second half period to the first scan line of the first half period of the next frame, the common voltage is also unchanged.

9. The dot inversion driving apparatus for an analog thin film transistor liquid crystal display panel as claimed in claim 6, wherein, the control circuit further provides a common voltage control signal amplified by an amplifying circuit to produce the common voltage.

10. A dot inversion driving method for an analog thin film transistor liquid crystal display panel, comprising:
(a) receiving grayscale signals of a thin film transistor liquid crystal display panel from the front step system;
(b) rearranging the orders and polarities of the grayscale signals;
(c) outputting the grayscale signals of a first group to the pixels of the first group using one scan line of the first group as a unit during a first half period of a frame; and
(d) outputting the grayscale signals of a second group to the pixels of the second group using one scan line of the second group as a unit during a second half period of the frame; wherein
the grayscale signals received in the step (a) change their polarities according to the line inversion mode;
the first group is the whole odd data lines or the whole even data lines of the thin film transistor liquid crystal display panel;
the second group is the whole data lines of the thin film transistor liquid crystal display panel deducting the first group;
in the grayscale signals of the first group, all the odd scan lines are of the first polarity while all the even scan lines are of the second polarity;
in the grayscale signals of the second group, all the odd scan lines are of the second polarity while all the even scan lines are of the first polarity.

11. The dot inversion driving method for an analog thin film transistor liquid crystal display panel as claimed in claim 10, wherein, the first polarity is one of the positive polarity and the negative polarity, and if the first polarity is of positive polarity, the second polarity is of negative polarity; if the first polarity is of negative polarity, the second polarity is of positive polarity.

12. The dot inversion driving method for an analog thin film transistor liquid crystal display panel as claimed in claim 10, wherein, the common voltage of the thin film transistor liquid crystal display panel is of direct current voltage.

13. The dot inversion driving method for an analog thin film transistor liquid crystal display panel as claimed in claim 10, wherein, the common voltage of the thin film transistor liquid crystal display panel is of alternating current voltage and when the grayscale signal output by the steps of (c) and (d) is of the first polarity, the common voltage is a first voltage; when the grayscale signal output by the steps of (c) and (d) is of the second polarity, the common voltage is a second voltage.

14. The dot inversion driving method for an analog thin film transistor liquid crystal display panel as claimed in claim 13, wherein, the first polarity is one of the positive polarity and the negative polarity, and
if the first polarity is of positive polarity, the second polarity is of negative polarity and the first voltage is lower than the voltage of the grayscale signal and the second voltage is higher than the voltage of the grayscale signal;
if the first polarity is of negative polarity, the second polarity is of positive polarity and the first voltage is higher than the voltage of the grayscale signal and the second voltage is lower than the voltage of the grayscale signal.

15. The dot inversion driving method for an analog thin film transistor liquid crystal display panel as claimed in claim 13, wherein, from the last scan line of the first half period to the first scan line of the second half period, the common voltage is unchanged; moreover, from the last scan line of the second half period to the first scan line of the first half period of the next frame, the common voltage is also unchanged.
